(19) United States
(12) Patent Application Publication
(10) Pub. No.: US 2012/0161715 A1
(43) Pub. Date: Jun. 28, 2012

(54) CELL BALANCING CIRCUIT, METHOD OF DRIVING THE SAME, AND BATTERY MANAGEMENT SYSTEM THAT INCLUDES THE CELL BALANCING CIRCUIT

(76) Inventor: Jong-Doo Park, Yongin-si (KR)

(21) Appl. No.: 13/240,866

(22) Filed: Sep. 22, 2011

(30) Foreign Application Priority Data
Dec. 22, 2010 (KR) 10-2010-0132828

(51) Int. Cl. H02J 7/00

(52) U.S. Cl. 320/136

(57) ABSTRACT

A battery management system (BMS) includes a cell balancing circuit. The cell balancing circuit includes a reference voltage generator that is coupled in parallel to at least one battery and generates a reference voltage, a comparator that compares a voltage output from a terminal of the battery with the reference voltage output from the reference voltage generator, and a transistor that discharges a current from the battery, when turned-on in response to a signal outputted from the comparator, through a discharge resistor coupled in series to the battery.

### CROSS-REFERENCE TO RELATED APPLICATION

This application claims the benefit of Korean Patent Application No. 10-2010-0132828, filed on Dec. 22, 2010, in the Korean Intellectual Property Office, the disclosure of which is incorporated herein in its entirety by reference.

### BACKGROUND

1. Field

Aspects of one or more embodiments according to the present invention relate to cell balancing circuits, and more particularly, to cell balancing circuits that can be applied to electric motor vehicles, methods of driving the cell balancing circuits, and battery management systems including the cell balancing circuits.

2. Description of the Related Art

Motor vehicles equipped with internal-combustion engines using gasoline or diesel as a main fuel can cause severe air pollution. In order to reduce air pollution, much effort has been made on developing electric or hybrid motor vehicles.

Electric motor vehicles use battery engines (e.g., electric motors) that are operated by electrical energy output from batteries. Electric motor vehicles use a battery pack including a plurality of secondary cells that can be charged and discharged as a main power source, and thus do not generate exhaust gas or much noise.

A hybrid motor vehicle is a cross between a motor vehicle (e.g., internal combustion engine powered vehicle) and an electric motor vehicle, and thus uses at least two engines, for example, an internal combustion engine and an electric motor. Currently developed mixed type hybrid motor vehicles use an internal combustion engine and a fuel cell in which electrical energy is directly obtained from a chemical reaction that is generated using a continuous supply of hydrogen and oxygen, or a battery and a fuel cell.

In an electric motor vehicle powered by a battery, the performance of the battery directly affects the performance of the motor vehicle. Therefore, cells of a battery should be maintained in a high performance state.

### SUMMARY

Aspects of one or more embodiments of the present invention are directed toward a battery management system that can effectively control charging and discharging of each cell of a battery by measuring voltages of the cells, and a voltage and a current of the battery.

Aspects of one or more embodiments of the present invention are directed toward cell balancing circuits that can manage problems with a battery management system or software by performing cell balancing using hardware.

Additional aspects will be set forth in part in the description which follows and, in part, will be apparent from the description, or may be learned by practice of the presented embodiments.

According to one or more embodiments of the present invention, there is provided a cell balancing circuit including: a reference voltage generator coupled in parallel to at least one battery, the reference voltage generator being configured to generate a reference voltage; a comparator for comparing a voltage output from a terminal of the at least one battery with the reference voltage; and a switch (e.g., a transistor) coupled in series to the at least one battery through a discharge resistor, the switch being configured to discharge a current from the at least one battery, when turned on in response to a signal output from the comparator, through the discharge resistor.

The reference voltage may include a first reference voltage, and the cell balancing circuit may be configured to determine whether or not the battery is overcharged based on the first reference voltage.

The comparator is configured to output a first voltage signal when the voltage of the at least one battery is greater than the first reference voltage.

The cell balancing circuit may further include a resistor coupled between the comparator and the switch.

The at least one battery may include at least two batteries; the comparator may include at least two comparators for respectively comparing battery voltages output from respective terminals of the at least two batteries with at least two reference voltages output from the reference voltage generator; and the discharge resistor may include at least two discharge resistors respectively coupled in parallel to the at least two batteries.

The at least two batteries may be independently cell balanced through the discharge resistors respectively.

The cell balancing circuit may further include a charge pump coupled between the reference voltage generator and at least one of the at least two comparators.

The reference voltage generator may be a low dropout (LDO) regulator or a regulator.

According to one or more embodiments of the present invention, there is provided a battery management system (BMS) including: a reference voltage generator coupled in parallel to a plurality of battery cells and configured to generate a reference voltage; a plurality of comparators respectively coupled to terminals of the battery cells and an output terminal of the reference voltage generator; a plurality of transistors respectively coupled to the comparators; and a plurality of discharge resistors respectively coupled between the terminals of the battery cells and the plurality of transistors.

The BMS may further include at least one charge pump coupled between the reference voltage generator and at least one of the plurality of comparators.

The BMS may further include a plurality of discharge resistors respectively coupled between the plurality of comparators and the plurality of transistors.

The BMS may be configured to determine whether or not the battery cells are overcharged based on the reference voltage.

The BMS may be configured to cell-balance the battery cells based on the reference voltage.

Each of the comparators is configured to turn-on a corresponding one of the transistors by outputting a voltage signal when a voltage of a corresponding one of the batteries is greater than the reference voltage.

According to one or more embodiments of the present invention, there is provided a method of driving a cell balancing circuit, the method including: generating a reference voltage; comparing a battery voltage output from a battery with the reference voltage; outputting a signal according to the comparison result; turning-on a transistor in response to the output signal; and discharging a current from the battery through a discharge resistor coupled in series to the battery.

### BRIEF DESCRIPTION OF THE DRAWINGS

These and/or other aspects of the present invention will become apparent and more readily appreciated from the following description of the embodiments, taken in conjunction with the accompanying drawings of which:

FIG. 1 is a schematic block diagram showing a battery, a battery management system (BMS), and peripheral elements of the BMS;

FIG. 2 is a schematic circuit diagram of a cell balancing circuit according to an embodiment of the present invention;

FIG. 3 is a schematic circuit diagram of a cell balancing circuit according to another embodiment of the present invention; and

FIG. 4 is a flow chart illustrating a method of driving a cell balancing circuit according to another embodiment of the present invention.

### DETAILED DESCRIPTION

The present invention will now be described more fully with reference to the accompanying drawings in which exemplary embodiments of the invention are shown. In the following descriptions, only elements or units that are needed to understand the operation according to the present invention are described, and other elements or units may be omitted.

Also, it will be understood that terms and words used in the specification and claims should not be interpreted as those only defined in commonly used dictionaries, and should be interpreted as having a meaning that is consistent with the meaning and concept of the technical spirit and scope of the present invention.

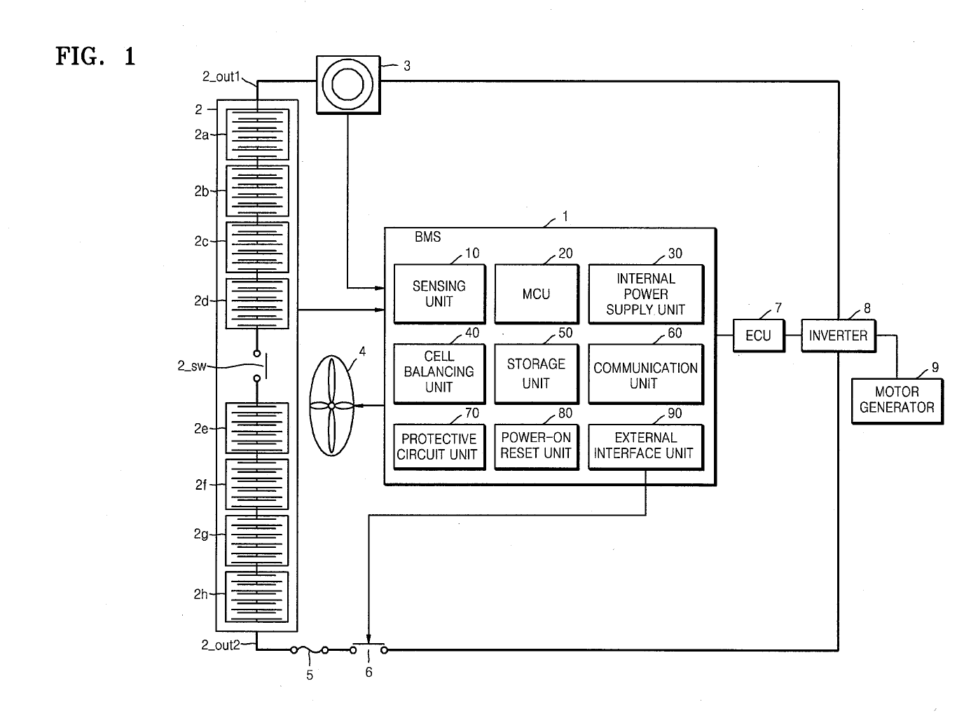

FIG. 1 is a schematic block diagram showing a battery, a battery management system (BMS), and peripheral elements of the BMS.

Referring to FIG. 1, a BMS 1, a battery 2, a current sensor 3, a cooling fan 4, a fuse 5, a main switch 6, an engine control unit (ECU) 7, an inverter 8, and a motor generator 9 are included in an electric motor vehicle.

The battery 2 includes a plurality of subpacks 2a through 2h, each including a plurality of cells coupled in series to each other. The battery 2 further includes an output terminal 2_OUT1, an output terminal 2_OUT2, and a safety switch 2_SW that is provided between the subpack 2d and the subpack 2e. In FIG. 1, eight subpacks 2a through 2h are depicted and each of the subpacks 2a through 2h represents a group of a plurality of cells according to an exemplary embodiment. However, the subpacks 2a through 2h are not limited thereto. The safety switch 2_SW is provided between the subpacks 2d and 2e to be manually turned on or off for the safety of operators when the battery 2 is being replaced or when work is being done on the battery 2. The safety switch 2_SW is provided between the subpacks 2d and 2e, and the output terminal 2_OUT1 and the output terminal 2_OUT2 are coupled to the inverter 8.

The current sensor 3 measures an amount of current output by the battery 2 and transmits the measurement to a sensing unit 10 of the BMS 1. In one embodiment, the current sensor 3 may be a hall current transformer (hall CT) that measures an output current using a hall device and outputs an analogue signal corresponding to the measurement.

The cooling fan 4 removes heat generated by charging/discharging the battery 2 from the battery 2 in response to a control signal of the BMS 1, and thus prevents the battery 2 from being degraded due to high temperature and a reduction of charge/discharge efficiency.

The fuse 5 prevents an overcurrent that is caused by a disconnected wire or a short circuit in the battery 2 from being transmitted to the battery 2. That is, when an overcurrent is generated, the fuse 5 is blown, and thus the overcurrent is not transmitted to the battery 2.

The main switch 6 turns on or off (or disconnects) the battery 2 in response to a control signal of the BMS 1 or the ECU 7 when an abnormal state, such as an overvoltage, an overcurrent, or a relatively high temperature, occurs. In FIG. 1, the main switch 6 is located in a negative path. However, the location of the main switch 6 is not limited thereto.

The BMS 1 includes the sensing unit 10, a main control unit (MCU) 20, an internal power supply unit 30, a cell balancing unit 40, a storage unit 50, a communication unit 60, a protective circuit unit 70, a power-on reset unit 80, and an external interface unit 90.

The sensing unit 10 measures a current of the battery 2 (hereinafter, a battery current), a voltage of the battery 2 (hereinafter, a battery voltage), temperatures of the cells, and ambient temperatures of the subpacks 2a through 2h, and transmits the measurements to the MCU 20. Also, the sensing unit 10 measures a voltage of the inverter 8, and transmits the measurement to the MCU 20.

The MCU 20 calculates a state of aging and a state of health (SOH) of the battery 2 by calculating a state of charging (SOC) and a variation of internal resistance of the battery 2 based on the measurements of the battery current, the battery voltage, the voltages of the cells, the temperatures of the cells, and the ambient temperature of the subpacks 2a through 2h, which are transmitted from the sensing unit 10. That is, the MCU 20 generates information indicating a state of the battery 2.

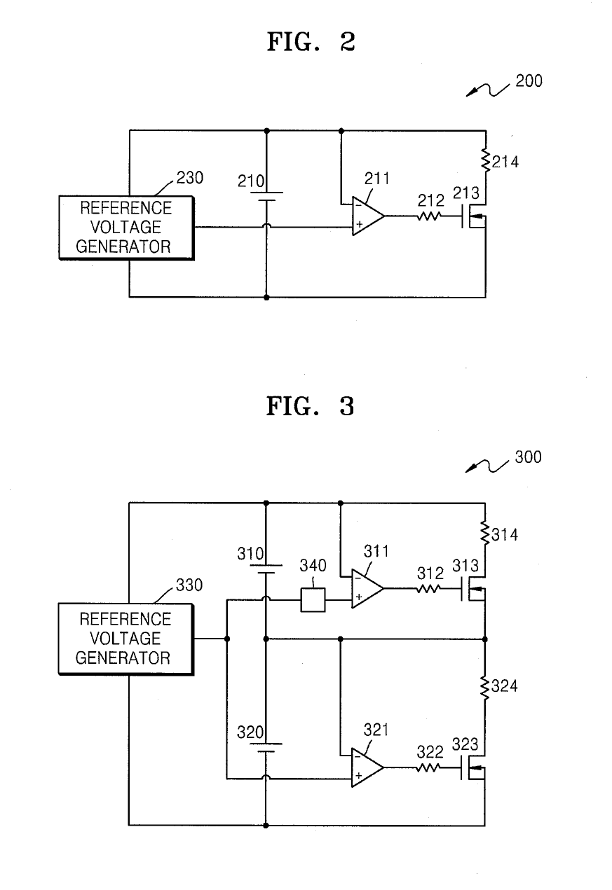

The internal power supply unit 30 is an apparatus for supplying power to the BMS 1 and generally includes an auxiliary battery. The cell balancing unit 40 balances a charge state of each of the cells. That is, cells that are relatively overcharged are discharged, and cells that are relatively undercharged are charged. The cell balancing is generally performed with software in the BMS 1. When there is a problem with the BMS 1, for example, a problem with the MCU 20 or a power supply failure, the BMS 1 may not perform cell balancing normally. In one embodiment, the balancing of cells is performed through a cell balancing circuit, that is, hardware, and not through a cell balancing operation by software of the BMS 1. Cell balancing circuits according to embodiments of the present invention will be described with reference to FIGS. 2 and 3.

The storage unit 50 stores current data pertaining to the SOC and the SOH when the BMS 1 is turned off. Here, the storage unit 50 may be a nonvolatile storage device that can electrically write and erase data. For example, the storage unit 50 may include an electrically erasable programmable read-only memory (EEPROM). The communication unit 60 communicates with the ECU 7 of an electrical motor vehicle. The communication unit 60 transmits information pertaining to the SOC and the SOH from the BMS 1 to the ECU 7, or transmits information about a state of the electrical motor vehicle from the ECU 7 to the MCU 20. The protective circuit unit 70 is a circuit for protecting the battery 2 using firmware. The power-on reset unit 80 resets the total system when the BMS 1 is turned on. The external interface unit 90 is a device for connecting auxiliary apparatuses of the BMS 1, such as the cooling fan 4 and the main switch 6, to the MCU 20. In FIG. 1, the cooling fan 4 and the main switch 6 are depicted. However, the embodiment of FIG. 1 is not limited thereto.

The ECU 7 checks a current driving state of the electrical motor vehicle based on information pertaining to an accelerator, a brake, and speed of the vehicle, and determines useful information such as torque information. More specifically, the current driving state of the electrical motor vehicle denotes information pertaining to a key-on operation, a key-off operation, a steady driving state, and an accelerating state. The ECU 7 transmits information pertaining to the driving state of the electrical motor vehicle to the communication unit 60 of the BMS 1. The ECU 7 controls an output of the motor generator 9 according to the torque information. That is, the ECU 7 controls an output of the motor generator 9 according to the torque information by controlling switching of the inverter 8. Also, the ECU 7 controls the SOC to be a target value (for example, 55%) by receiving the SOC of the battery transmitted from the MCU 20 through the communication unit 60 of the BMS 1. For example, when the SOC transmitted from the MCU 20 is below 55%, the ECU 7 controls the switching of the inverter 8 to output electric power to the battery 2 to charge the battery 2, and in this case, the battery current ib is negative. However, when the SOC is greater than 55%, the ECU 7 controls the switching of the inverter 8 to output electric power to the motor generator 9 to discharge the battery 2, and in this case, the battery current ib is positive.

The inverter 8 controls charging or discharging of the battery 2 in response to a control signal of the ECU 7. Also, the inverter 8 transforms power of the battery 2 and transmits the transformed power to the motor generator 9.

The motor generator 9 drives the electrical motor vehicle in response to the torque information transmitted from the ECU 7 by using electrical energy of the battery 2.

The ECU 7 prevents or protects the battery 2 from being overcharged and from being over-discharged by appropriately charging and discharging the battery 2 in response to the SOC, and thus enables the battery 2 to be efficiently operated for a period of time. Although it is difficult to measure the SOC after the battery 2 is mounted on the electrical motor vehicle, the BMS 1 is able to transmit the SOC after correctly estimating the SOC by using the battery voltage, the battery current, and the cell temperatures sensed by the sensing unit 10.

FIG. 2 is a circuit diagram of a cell balancing circuit 200 according to an embodiment of the present invention. The cell balancing circuit 200 may be a part of the BMS 1 of FIG. 1 or a circuit separate from the BMS 1.

Referring to FIG. 2, the cell balancing circuit 200 includes a battery 210, a comparator 211 that is coupled to a positive terminal of the battery 210 and an output terminal of a reference voltage generator 230, a resistor 212, a transistor 213, and a discharge resistor 214. In FIG. 2, the battery 210 is depicted as a single battery. However, the embodiment depicted in FIG. 2 is not limited thereto.

The reference voltage generator 230 is coupled in parallel to the battery 210 and generates a reference voltage using a voltage of the battery 210. Here, the reference voltage is a voltage used to determine whether the battery 210 is to be cell-balanced. For example, when the voltage of the battery 210 is greater than the reference voltage (e.g., greater than 4.2V), it is determined that the battery 210 is to be cell-balanced. The reference voltage generator 230 may be a regulator, for example, a low dropout (LDO) regulator, but is not limited thereto. The LDO regulator can generate an output voltage (e.g., a predetermined voltage) using a low input-voltage.

The comparator 211 compares the voltage of the battery 210 to the reference voltage output from the reference voltage generator 230. For example, when the voltage of the battery 210 is greater than the reference voltage (e.g., 4.2 V), the comparator 211 generates a signal, for example, a voltage signal having a voltage (e.g., a predetermined voltage) that is able to turn on the transistor 213. However, when the voltage of the battery 210 is lower than 4.2V, the comparator 211 maintains an off-state, and outputs no signal. That is, the comparator 211 determines whether or not the battery 210 is to be cell-balanced.

The resistor 212 controls the voltage signal of the comparator 211.

The transistor 213 is turned on in response to the voltage signal output from the comparator 211 to discharge a current from the battery 210 through the discharge resistor 214. That is, the turning-on of the transistor 213 forms a current path between the battery 210 and the discharge resistor 214, and a cell balancing of the battery 210 is performed by discharging a current from the battery 210. When the voltage of the battery 210 is reduced to be lower than the reference voltage, the transistor 213 is turned off, and thus, no current flows between the battery 210 and the discharge resistor 214. Here, the transistor 213 may be an N-channel metal oxide semiconductor (NMOS) transistor or a P-channel metal oxide semiconductor (PMOS) transistor, but the embodiment depicted in FIG. 2 is not limited thereto.

Accordingly, the cell balancing is performed by discharging a current from the battery 210 through the discharge resistor 214, and whether or not the battery 210 is to be cell-balanced is determined not by software of the BMS 1 but by hardware.

FIG. 3 is a circuit diagram of a cell balancing circuit 300 according to another embodiment of the present invention. The cell balancing circuit 300 may be a part of the BMS 1 of FIG. 1 or a circuit separate from the BMS 1.

Referring to FIG. 3, the cell balancing circuit 300 includes a reference voltage generator 330 coupled to two batteries 310 and 320 in parallel, a comparator 311 that receives a voltage from a terminal of the battery 310 and a reference voltage output from the reference voltage generator 330, and a comparator 321 that receives a voltage from a terminal of the battery 320 and the reference voltage output from the reference voltage generator 330. The comparators 311 and 321 respectively determine whether or not the batteries 310 and 320 are to be cell-balanced. A charge pump 340 is coupled between the reference voltage generator 330 and the comparator 311. The charge pump 340 transfers charges and generates a suitable output voltage by combining an input voltage and a voltage charged in a condenser. When the reference voltage generated by the reference voltage generator 330 is applied to both the comparators 311 and 321, the reference voltage is reduced by being divided into two portions. In order to compensate for the reduction of the reference voltage, the charge pump 340 increases a voltage being applied to the comparator 311 to the reference voltage. In the embodiment shown in FIG. 3, two comparators 311 and 321 are depicted in FIG. 3, but the present invention is not limited thereto.

The comparators 311 and 321 respectively compare the voltages of the batteries 310 and 320 to the reference voltage. Signals output from the comparators 311 and 321 are transmitted to transistors 313 and 323 through resistors 312 and 322, respectively. The cell balancing of each of the batteries 310 and 320 is independently performed. That is, the cell balancings of the batteries 310 and 320 are respectively performed in response to the signals output from the comparators 311 and 321. When the signals are output from the comparators 311 and 321, the signals for turning on the transistors 313 and 323 are output through the resistors 312 and 322, respectively.

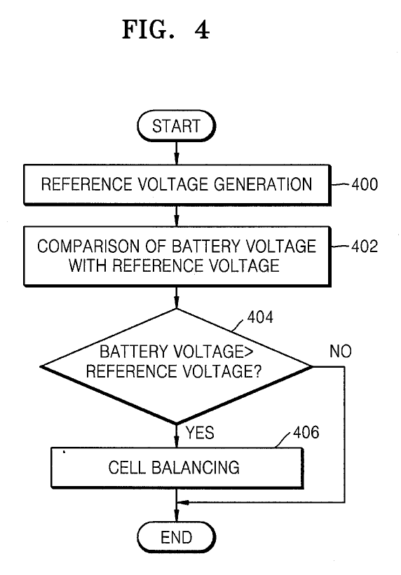

FIG. 4 is a flow chart illustrating a method of driving a cell balancing circuit according to an embodiment of the present invention.

Referring to FIG. 4, a reference voltage is generated (Step 400). Here, the reference voltage is used to determine whether a battery is to be cell-balanced. A voltage of the battery is compared with the reference voltage (step 402).

When the voltage of the battery is greater than the reference voltage (step 404), the comparator outputs a signal to turn on a transistor to form a current path between the battery and a discharge resistor, and thus a current is discharged from the battery (step 406).

In the embodiment depicted in FIG. 4, the generation of a reference voltage, the comparison of the voltage of a battery with the reference voltage, and the cell balancing of the battery are performed with hardware. Therefore, weak points of cell balancing performed with software in a BMS of the related art can be compensated for. Also, problems with a battery management system or software can be appropriately handled.

For the purposes of promoting an understanding of the principles of the invention, reference has been made to the exemplary embodiments illustrated in the drawings, and specific language has been used to describe these embodiments. However, no limitation of the scope of the invention is intended by this specific language, and the present invention should be construed to encompass all embodiments that would normally occur to one of ordinary skill in the art.

The particular implementations shown and described herein are illustrative examples of the invention and are not intended to otherwise limit the scope of the invention in any way. For the sake of brevity, conventional electronics, control systems, software development and other functional aspects of the systems may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The present invention is not limited to the described order of the steps. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the present invention, which is to be defined by the attached claims and equivalents thereof.

What is claimed is:

1. A cell balancing circuit comprising:
a reference voltage generator coupled in parallel to at least one battery and configured to generate a reference voltage;
a comparator for comparing a voltage output from a terminal of the at least one battery with the reference voltage; and
a switch coupled in series to the at least one battery through a discharge resistor, the switch being configured to discharge a current from the at least one battery, when turned on in response to a signal output from the comparator, through the discharge resistor.

2. The cell balancing circuit of claim 1, wherein the reference voltage comprises a first reference voltage, and the cell balancing circuit is configured to determine whether or not the battery is overcharged based on the first reference voltage.

3. The cell balancing circuit of claim 2, wherein the comparator is configured to output a first voltage signal when the voltage of the at least one battery is greater than the first reference voltage.

4. The cell balancing circuit of claim 1, further comprising a resistor coupled between the comparator and the switch.

5. The cell balancing circuit of claim 1,
wherein the at least one battery comprises at least two batteries;
wherein the comparator comprises:
at least two comparators for respectively comparing battery voltages output from respective terminals of the at least two batteries with at least two reference voltages output from the reference voltage generator; and
wherein the discharge resistor comprises:
at least two discharge resistors respectively coupled in parallel to the at least two batteries.

6. The cell balancing circuit of claim 5, wherein the at least two batteries are independently cell-balanced through the at least two discharge resistors respectively.

7. The cell balancing circuit of claim 5, further comprising a charge pump coupled between the reference voltage generator and at least one of the at least two comparators.

8. The cell balancing circuit of claim 1, wherein the reference voltage generator comprises a low dropout (LDO) regulator or a regulator.

9. A battery management system (BMS) comprising:
a reference voltage generator coupled in parallel to a plurality of battery cells and configured to generate a reference voltage;
a plurality of comparators respectively coupled to terminals of the battery cells and an output terminal of the reference voltage generator;
a plurality of transistors respectively coupled to the comparators; and
a plurality of discharge resistors respectively coupled between the terminals of the battery cells and the plurality of transistors.

10. The BMS of claim 9, further comprising at least one charge pump coupled between the reference voltage generator and at least one of the plurality of comparators.

11. The BMS of claim 9, further comprising a plurality of first resistors respectively coupled between the plurality of comparators and the plurality of transistors.

12. The BMS of claim 9, wherein the BMS is configured to determine whether or not the batteries are overcharged based on the reference voltage.

13. The BMS of claim 9, wherein the BMS is configured to cell-balance the battery cells based on the reference voltage.

14. The BMS of claim 9, wherein each of the comparators is configured to turn on a corresponding one of the transistors by outputting a voltage signal when a voltage of a corresponding one of the batteries is greater than the reference voltage.

15. A method of driving a cell balancing circuit, the method comprising:
generating a reference voltage;
comparing a battery voltage output from a battery with the reference voltage;
outputting a signal according to the comparison result;
turning on a transistor in response to the output signal; and
discharging a current from the battery through a discharge resistor coupled in series to the battery.
